(19) United States
(12) Patent Application Publication
(10) Pub. No.: US 2024/0410604 A1
(43) Pub. Date: Dec. 12, 2024

(54) FURNITURE ITEM WITH INTEGRATED AIR FILTRATION SYSTEM

(71) Applicants: Paul Robert Fioroni, Lubbock, TX (US); Kevin William Mayoux, Prosper, TX (US)

(72) Inventors: Paul Robert Fioroni, Lubbock, TX (US); Kevin William Mayoux, Prosper, TX (US)

(21) Appl. No.: 18/604,335

(22) Filed: Mar. 13, 2024

Related U.S. Application Data
(63) Continuation of application No. PCT/US23/24626, filed on Jun. 6, 2023.

(51) Int. Cl. F24F 8/10; A47B 13/02; B01D 46/42

(52) U.S. Cl. CPC F24F 8/10; A47B 13/02; B01D 46/4245; A47B 2200/06; B01D 2279/65; F24F 2221/18

(57) ABSTRACT

Disclosed is an air filtration system comprising a furniture item which may be a table; and at least one air filtration unit configured to integrate with the furniture item. In embodiments, the air filtration system includes at least one integrated receptacle configured to receive the air filtration unit and air channels in fluid communication with the receptacle, wherein the air channels are configured to channel filtered air from the air filtration unit.

### RELATED APPLICATION

This is a continuation application of International Application (PCT) number PCT/US23/24626 filed Jun. 6, 2023, which is hereby incorporated by reference herein in its entirety.

### BACKGROUND

The present disclosure relates generally to air filtration systems.

Maintaining cleaner air indoors may reduce the spread of air borne diseases, allergens, pollution, and other potentially harmful substance for an overall healthier environment. As such, an improved air filtration system is desirable.

### SUMMARY

According to various embodiments, disclosed is an air filtration system comprising a furniture item, and at least one air filtration unit configured to integrate with the furniture item. In some embodiments, the furniture item may be a table. The air filtration system may include at least one integrated receptacle configured to receive the air filtration unit and ventilation passage(s) or air channels which are in fluid communication with the receptacle and configured to channel filtered air from the air filtration unit. In some embodiments, the receptacle may be configured to activate and/or power the air filtration unit when inserted into the receptacle.

### BRIEF DESCRIPTION OF THE FIGURES

The detailed description of some embodiments of the invention will be made below with reference to the accompanying figures, wherein the figures disclose one or more embodiments of the present invention.

FIG. 1 is a perspective view of a table including an integrated air filtration system, according to various embodiments.

FIG. 2 is an exploded view thereof.

FIG. 3 is a section view taken along line 3-3 in FIG. 1.

FIG. 4 is a detailed section view of the table, illustrating air flow.

FIG. 5 is a section view taken along line 5-5 in FIG. 5.

### DETAILED DESCRIPTION OF CERTAIN EMBODIMENTS

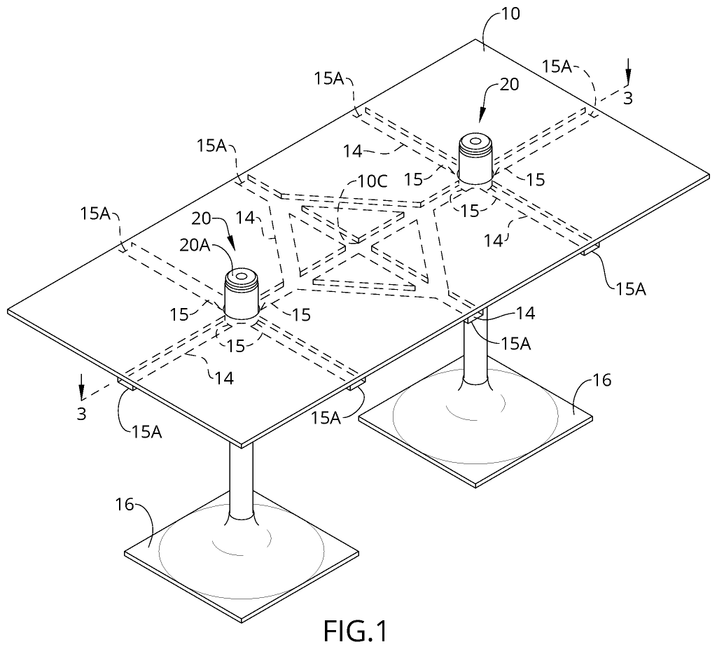

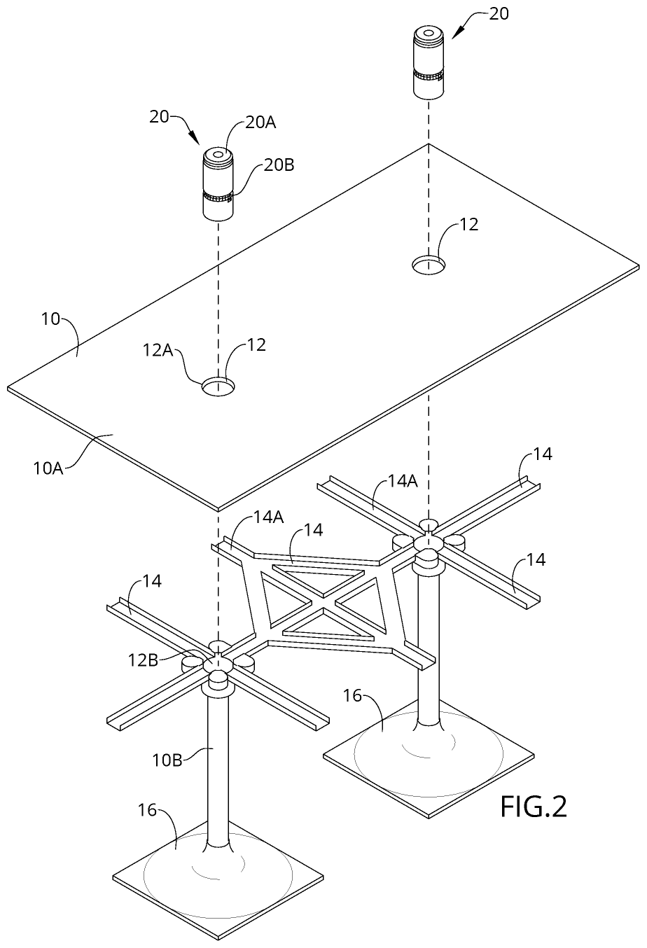

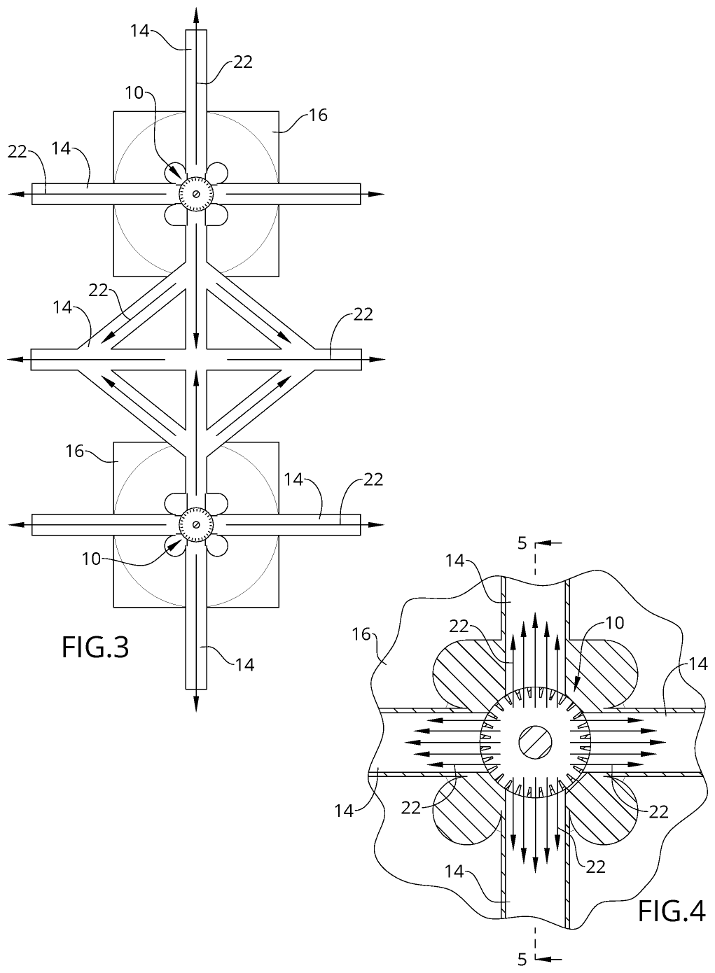

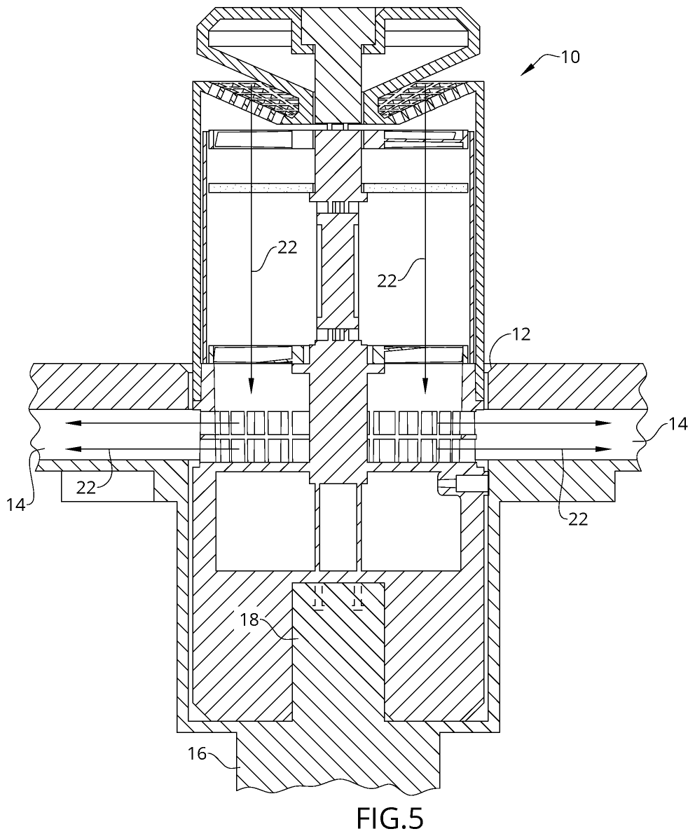

According to various embodiments as depicted in FIGS. 1-5, disclosed is an air filtration system comprising a furniture item 10 incorporating at least one air channel 14, and configured to receive at least one air purifier, i.e., air filtration unit 20, the air filtration unit 20 being configured to integrate with the furniture item 10 for purifying air and conveying the purified air through air channel(s) 14. In embodiments as depicted in the figures, the furniture item may be a table including a tabletop 10A and one or more support leg(s) 10B, but is not limited to this option.

In certain embodiments, the furniture item/table 10, may include at least one receptacle 12 sized and shaped to receive and retain air filtration unit 20. In further embodiments, receptacle 12 may be integrated with the structure of furniture item 10. In some further embodiments, receptacle 12 may be configured to activate the air filtration unit 20 upon proper insertion of air filtration unit 20 into receptacle 12.

In certain embodiments air channel(s) 14 may be integrated into the structure of furniture item 10, and includes at least one channel inlet 15 and at least one channel outlet 15A, wherein the channel inlet 15 is configured to align with an outlet 20B (“airflow exit”) of air filtration unit 20 when the air filtration unit is inserted into receptacle 12, for enabling purified air to enter channel(s) 14. As such, air channel(s) 14 may receive purified air from air filtration unit 20 at channel inlet 15 and convey the purified air out through channel outlet 15A. In some embodiments relating to a table furniture item, air channel(s) 14 may be provided below tabletop 10A, and may further be configured to laterally support tabletop 10A, but not necessarily so. In one embodiment, air channel(s) 14 may comprise ducts 14A that form a lower enclosure section of air channels 14, wherein tabletop 10A forms an upper enclosure thereof. In alternate embodiments, air channel(s) 14 may be separately enclosed independent of tabletop 10A.

In further embodiments relating to a table furniture item, receptacle 12 may comprise an opening 12A within tabletop 10A and a holder 12B which sits below opening 12A and/or tabletop 10A, wherein outlet 20B of filtration unit 20 is configured to sit within holder 12B and align with air channel(s) 14/air channel inlet(s) 15, when air filtration unit 20 is installed within receptacle 12. In certain embodiments, an air inlet 20A (“airflow entrance”) of air filtration unit 20 may be configured to extend above tabletop 10A when air filtration unit 20 is installed within receptacle 12.

In one embodiment as depicted in the figures, holder 12B may be nested within a top portion of the table's support legs 10B and ducts 14A may extend laterally therefrom. Additionally, air channels 14/air ducts 14A may extend to approximately the tabletop's perimeter edge to provide airflow outlets 14B at the table's side edge(s). As such, airflow 22 into air inlet 20A of air filtration unit 20 is purified and exits air outlet 20B, wherein it may be directed through air channels 14 to exit at the side/perimeter edges of tabletop 10A for providing filtered air where individuals may be sitting.

In certain embodiments, air filtration unit 20 may be configured to activate upon insertion into receptacle 12. In some embodiments, receptacle 12 may comprise a table power outlet plug 18, wherein air filtration unit 20 is configured to electrically couple with outlet plug 18 and activate when inserted into receptacle 12. In some embodiments, filtration unit 20 may include a switch and receptacle 12 may comprise a corresponding switch turn-on mechanism which turns the switch on when filtration unit 20 is properly inserted. In other embodiments, filtration unit 20 may automatically activate upon connection to outlet plug 18. In some embodiments, outlet plug 18 within receptacle 12 may include a battery, and/or electrical wiring which may run through the table leg and connects to an outlet near the table. It shall be appreciated however, that air filtration unit 20 may be configured to independently power and/or activate in alternate embodiments. For example, air filtration unit 20 may comprise a battery and an on-off switch which allows the user to turn on the unit before inserting into receptacle 12.

In certain embodiments, table 10 may be configured to receive one or more than one air filtration units 20, and may include any number airflow channels and/or inlets 14A and outlets 14B. In some embodiments, table 10 may comprise multiple support legs 10B, wherein each leg may comprise a receptacle 12 for receiving a separate air filtration unit 20. As such, table 10 may be configured to receive multiple air filtration units 20, which may be distributed along the table. According to an exemplary embodiment as depicted in the figures, table 10 may be rectangular and may comprise 2 cylindrical legs 10B, each leg including a wide support base 16 and located approximately between a midpoint 10C and a lateral edge of the tabletop. Each leg may further comprise 4 ducts 14A branching out from receptacle 12 in cross alignment, wherein 3 of the ducts in each leg extend directly to the table's perimeter edge, and a fourth inner duct in each leg branches to confluence with the corresponding duct of the other leg, wherein additional ducts branch out from the confluence point to provide further duct outlets at opposite transverse edges of the table as shown.

In another example, a circular or square table 10 may comprise a single central receptacle 12, wherein multiple ducts 14A/channels 14 may branch radially outwards therefrom to the outer perimeter edge(s) of the table. The channels may be evenly/symmetrically distributed to indicate sitting areas around the table and/or to provide an even distribution of filtered air around the table.

It shall be appreciated that different channel/duct configurations may be provided in alternate embodiments. It shall be appreciated that any number of channel(s)/duct(s) may be provided in alternate embodiments. It shall be appreciated that table 10, receptacle 12, and air filtration unit 20 may have different geometric configurations (e.g., square, rounded, oval, etc.), and size dimensions in alternate embodiments. Furthermore, receptacle(s) 12 need not necessarily nest within the table legs in alternate embodiments. Additionally, table 10 may have any number of legs, or no legs in alternate embodiments. In some embodiments, support leg(s) 10B, ducts 14A, and/or tabletop 10A may be attachable and detachable to provide a modular table design.

The disclosed system thus provides a cleaner air environment, and may reduce the spread of viral, bacterial, and fungal airborne pathogens, to limit the spread of diseases such as coronavirus, flu, etc. In embodiments, the disclosed system may be ideal for restaurant dining and other social activities, office/work meetings, and the like. The disclosed system creates a safer environment where harmful pathogens may be restricted from spreading, and wherein individuals sitting around the table may breathe a higher concentration of cleaner air.

It shall be appreciated that the disclosed furniture integrated air filtration system can have multiple configurations in different embodiments. In one embodiment, the air channels may include closure flaps. Additionally, the filtration unit may be removed when not needed or desired. In some embodiments, a cover for the receptacle opening, which aligns with the table surface may be provided for covering the receptacle void when the air filtration unit is not in use.

In certain embodiments, the disclosed system may incorporate additional elements, such as cooling and/or heating components, a UV element, a fan element, speakers, microphones, smart system components, air scenting components, lighting components, data capturing components, etc. Such additional components may be incorporated within the air filtration unit and/or furniture item. As such, the disclosed system may be used for cooling, heating, cleaning/thermal filtration, and/or air circulation. The disclosed system may also be adapted for applications such as air quality testing, air heating and cooling, sound system, odor control and/or air scenting system, lighting system, data capturing system, and the like.

It shall be appreciated that the disclosed air filtration system may be integrated with various types of tables (e.g., dining tables, conference tables, desks, etc.), and other furniture items, such as chairs, closets, lamps, beds, etc. It shall be appreciated that the components of the air filtration system described in several embodiments herein may comprise any alternative known materials in the field and be of any size and/or dimensions. In one example, a table furniture item may be made of material(s) such as metal, wood, plastic, etc. It shall be appreciated that the components of the air filtration system described herein may be manufactured and assembled using any known techniques in the field. Furthermore, the components of the disclosed system may be provided as an assembled and/or integral unit or may be provided as a modular system or assembly of parts according to alternate embodiments.

It shall be understood that the orientation or positional relationship indicated by terms such as “upper”, “lower”, “front”, “rear”, “left”, “right”, “top”, “bottom”, “inside”, “outside” is based on the orientation or positional relationship shown in the accompanying drawings, which is only for convenience and simplification of describing the disclosed subject matter, rather than indicating or implying that the indicated device or element must have a specific orientation or are constructed and operated in a specific orientation, and therefore should not be construed as a limitation of the present invention.

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An air filtration system, comprising:
a furniture item configured to receive an air filtration unit; and
at least one air channel in the furniture item,
wherein the air channel includes at least one channel inlet and at least one channel outlet,
wherein the channel inlet is configured to align with an airflow exit of the air filtration unit and to receive purified air from said airflow exit when the air filtration unit is activated and installed within the furniture item,
wherein the air channel is configured to convey the purified air from the air filtration unit to the channel outlet.

2. The air filtration system of claim 1, wherein the furniture item is a table.

3. The air filtration system of claim 2, wherein the air channel is provided below a tabletop of the table.

4. The air filtration system of claim 3, wherein the air channel outlet configured to provide purified air around a perimeter edge section of the tabletop.

5. The air filtration system of claim 3, wherein the air channel comprises at least one duct that forms a lower enclosure section of the air channel, and wherein the tabletop forms an upper enclosure of the air channel.

6. The air filtration system of claim 5, wherein the tabletop includes at least one opening into which the air filtration unit can be inserted such that an airflow entrance of the air filtration unit positions above the tabletop when the air filtration unit is inserted into the opening and the channel inlet of the air channel is aligned with the airflow exit of the air filtration unit.

7. The air filtration system of claim 6, further comprising at least one table support leg configured to support the tabletop; and a holder nested within a top portion of the support leg and configured to hold the air filtration unit in alignment with the air channel.

8. The air filtration system of claim 1, wherein the air filtration unit is a component of the air filtration system and is configured to integrate with the furniture item.

9. The air filtration system of claim 7, wherein the furniture item includes at least one receptacle sized and shaped to receive and retain the air filtration unit.

10. The air filtration system of claim 8, wherein the receptacle is configured to activate the air filtration unit upon insertion of the air filtration unit into the receptacle.
